(19) United States
(12) Patent Application Publication
(10) Pub. No.: US 2014/0208519 A1
(43) Pub. Date: Jul. 31, 2014

(54) AIR CYLINDERS FOR MATTRESS

(71) Applicant: ARNOLD BALONICK, Encino, CA (US)

(72) Inventor: ARNOLD BALONICK, Encino, CA (US)

(21) Appl. No.: 14/164,233

(22) Filed: Jan. 26, 2014

Related U.S. Application Data
(60) Provisional application No. 61/757,702, filed on Jan. 28, 2013.

(51) Int. Cl. A61G 7/057

(52) U.S. Cl. CPC A61G 7/05769
USPC 5/709

(57) ABSTRACT

The present invention is an improved air cylinder for air mattresses primarily intended for hospitals, long-term care facilities and in-home use. Each elongated flexible air cylinder contains a foam member with a generally square cross-section and area to enclose a volume of air above the foam member. When one or more air cylinders are connected to a pump and pressure to air cylinders is increased, the area above the foam members enclosed by the flexible air cylinders inflates with air. The volume above the foam member in each flexible air cylinder can retain enough pressure to lift the portion of the patient's body above that air cylinder away from the resilient foam member. The flexible air cylinders may be connected to achieve an alternating pressure cycle where one set of air cylinders may be pressurized while other air cylinders are allowed to evacuate air and become depressurized.

### CROSS-REFERENCE TO RELATED APPLICATION

This patent application claims the benefit of Provisional Patent Application No. 61/757,702 filed on Jan. 28, 2013.

### FEDERALLY SPONSORED RESEARCH

Not Applicable

### SEQUENCE LISTING OR PROGRAM

Not Applicable

### BACKGROUND

The present invention relates to non-powered and powered air mattresses primarily intended for hospitals, long-term care facilities and in-home use. Such air mattresses are designed to prevent or limit the creation of ulcers on the body of the patient during long periods of lying on the mattress.

U.S. Pat. No. 5,634,224 to Gates describes a cushioning device comprising an envelope containing a fluid in which the envelope has a pressure relief valve and an intake valve to regulate the deformation of the envelope under the load and reformation of the envelope when the load is removed. U.S. Pat. No. 6,223,369 to Maier describes patient support surfaces that use different arrangements of air cylinders and static or dynamic performance thereof, either non-powered or powered. An external valve arrangement for a static non-powered embodiment permits practice of a “recharging” technique using an air pump and self-calibrated valve, to return the air pressure in static air cylinders to their original manufactured specifications. U.S. Pat. No. 7,886,386 to Balonick describes an air mattress comprising multiple foam layers and an air sector having multiple resilient foam filled air cylinders. The air cylinders, within a of a flexible fabric sleeve, may be filled with foam having different densities and multiple layers. Each air cylinder has an air inlet connected to the atmosphere by an inlet valve and an air outlet that may be restricted by an internal check valve or connected to a pump.

However, in U.S. Pat. Nos. 5,634,224 and 6,223,369, the patient on the mattress remains upon a deforming material such as foam, water or some other resilient support material at all times. To prevent or limit the creation of ulcers on the patient's body during long periods of lying on a mattress, the patient must be occasionally removed from the bed or deforming material. By alternating support of the patient on the mattress between deforming material and air, ulcers on the body of the patient can be prevented or limited. U.S. Pat. No. 7,886,386 allows for a pump to be used to pressurize the mattress and alternate support of the patient between deforming material and air, but the transition between pressurized and non-pressurized mattress may be abrupt. For the foregoing reasons, there is a need for a mattress that can subtly alternate support of a patient between a deforming material and air pressure.

The present invention improves upon U.S. Pat. No. 7,886,386 by comprising flexible air cylinders with an arched top and foam members within the air cylinders. Unlike the air cylinders in U.S. Pat. No. 7,886,386, which have a square cross section, the air cylinders with an arched top in the present invention can enclose a volume of air between the foam member and patient.

### SUMMARY

The present invention, an improvement to U.S. Pat. No. 7,886,386, is directed to the air cylinders of an air mattress that satisfies the need to alternate support of a patient between a deforming material such as foam and air in a subtle manner. The apparatus alternates support of a patient between a foam member and air in a subtle manner by incorporating an arched top into each air cylinder. When an air cylinder with an arched top is inflated with air, the arched top will slowly expand and enclose a volume of air above the foam member within the air cylinder. Because the arched top allows for a volume of air to be enclosed above the foam member, the portion of the patient above the particular cylinder being filled with air will be gently elevated above the foam member. This improved air cylinder allows for the alternating of patient support on the mattress between deforming material and air.

### DRAWINGS

FIG. 1A illustrates an exploded view of a non-powered air mattress embodying features of the present invention.

FIG. 1B is an enlarged sectional view illustrating the foam member within the elongated flexible air cylinder of the mattress shown in FIG. 1A.

FIG. 1C is cross-sectional view illustrating the foam member within the elongated flexible air cylinder of the mattress shown in FIG. 1A.

FIG. 2A illustrates a side view of a non-powered air mattress embodying features of the present invention.

FIG. 2B is an enlarged view illustrating the air inlet/outlet connections of the mattress shown in FIG. 2A.

FIG. 3A illustrates a side view of a powered air mattress embodying features of the present invention.

FIG. 3B is an enlarged view illustrating the air inlet/outlet connections of the mattress shown in FIG. 3A.

FIG. 4 is an exploded view of a powered air mattress embodying features of the present invention.

FIG. 5 is a cross-sectional view of an alternate embodiment of the present invention illustrating the foam member within the elongated flexible air cylinder

FIG. 6A is an enlarged sectional view of an alternate embodiment illustrating the foam member within the elongated flexible air cylinder of the mattress.

FIG. 6B is a cross-sectional view of an alternate embodiment of the present invention illustrating the foam member within the elongated flexible air cylinder.

FIG. 7A is a perspective view of an alternate embodiment of an air mattress embodying features of the present invention.

FIG. 7B is a top and side elevation view of the air mattress shown in FIG. 7A.

FIG. 8 is an exploded view of an alternate embodiment of an air mattress embodying features of the present invention.

FIG. 9 is a perspective view of the air mattress air sector and system sleeves of an air mattress embodying features of the present invention.

FIG. 10 is a top view of the air sector and connectors of an air mattress embodying features of the present invention.

FIGS. 11A-C are side sectional views of preferred alternate embodiments of air cylinders with multiple foam layer arrangements and air space embodying features of the present invention.

### DESCRIPTION

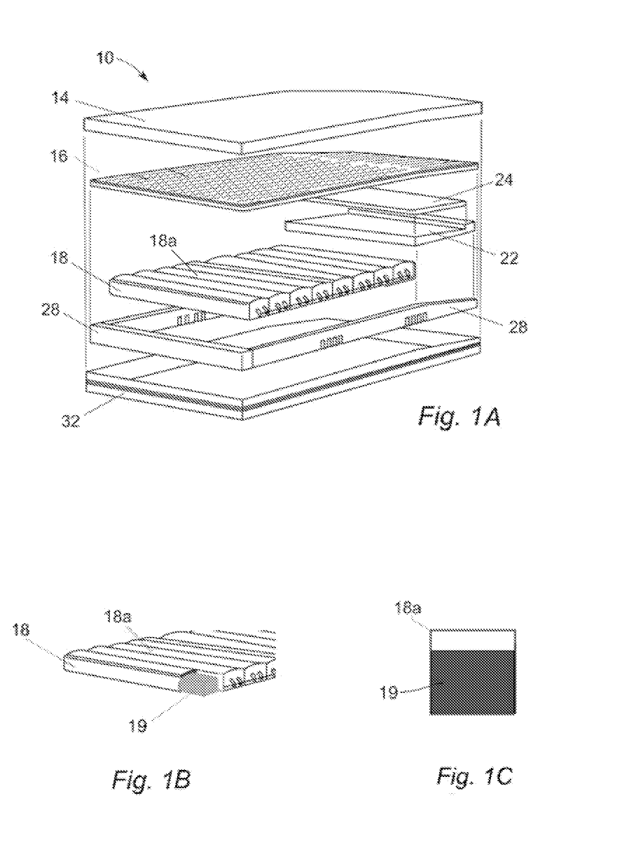

The present invention, an improvement to U.S. Pat. No. 7,886,386, is directed to the air cylinders of air mattresses primarily intended for hospitals, long-term care facilities and in-home use. FIGS. 1-4 show an air mattress 10 with air sector 18 and air cylinders 18a according to embodiments of the present invention. The flexible air cylinders 18a are constructed with an arched top and a foam member 19.

FIG. 1A illustrates a non-powered air mattress 10 with flexible air cylinders 18a according to the present invention. The air sector 18 of the present invention comprises elongated flexible air cylinders 18a, each filled with a resilient foam member 19. The resilient foam member 19 has a square cross-section as best illustrated in FIGS. 1B-1C. The flexible air cylinders 18a comprise a flat bottom, straight sides perpendicular to the flat bottom, and an arched top to enclose a volume of air above the foam member 19 within the flexible air cylinder 18a.

FIG. 1A further illustrates components that may be incorporated into the air mattress 10 of the present invention. An air permeable top cover 14 and foam layer 16 is placed above the air sector 18, while a heel support 22 and heel pillow 24 are also included. A U-shaped side/end rail 28 and a bottom cover 32 surround these components.

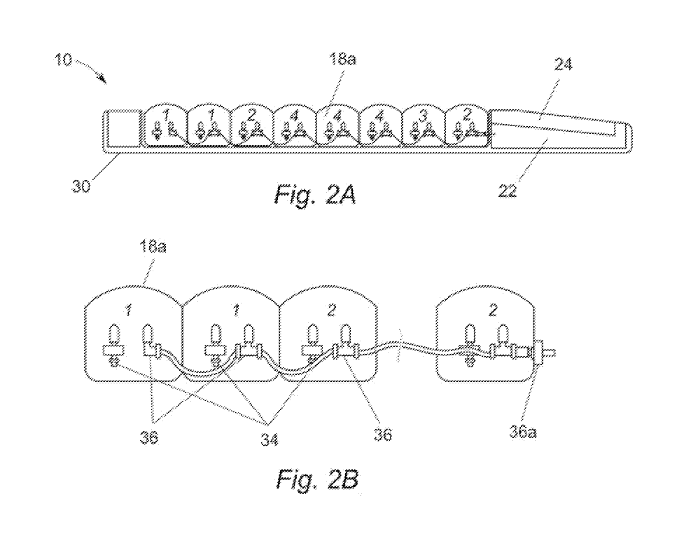

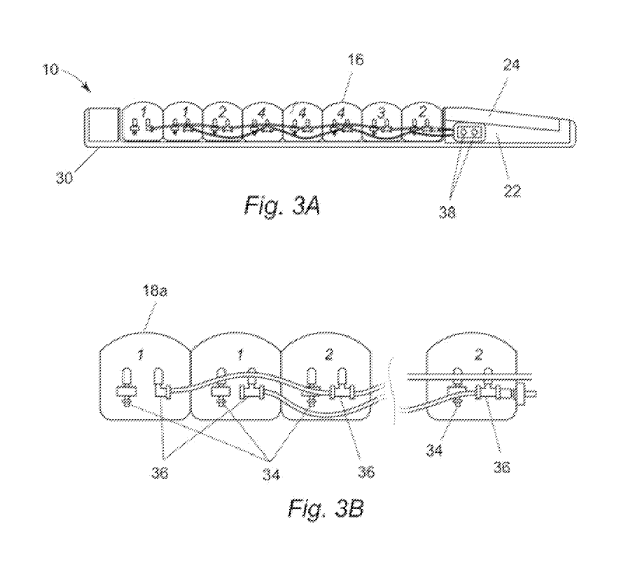

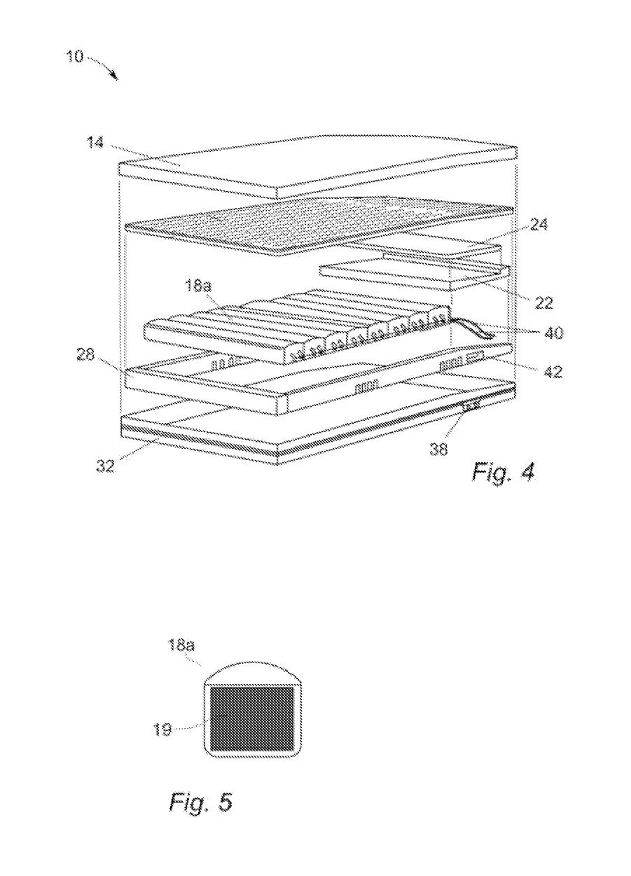

FIGS. 2A-2B illustrate the flexible air cylinders 18a of a non-powered air mattress 10 having an air inlet 34 and an air outlet 36 on the end of each air flexible cylinder 18a. The air inlets 34 are connected to the atmosphere through inlet valves (not shown), and the air outlets 36 are connected together in several arrangements. For a mattress that is not connected to a pump (i.e. non-powered), the outlets 36 of all flexible air cylinders 18a are connected together in series and connected to a single restricted internal check outlet valve 36a. FIGS. 3A-3B and 4 illustrate an air mattress 10 that is connected to a pump (i.e. powered), the outlets 36 of alternating flexible air cylinders 18a are connected together, and the two sets of outlets are connected to two hose connectors 38 on the side of the mattress 10 which may be connected to a pump using two tubes 40 through a cutout 42 on U-shaped side/end rail 28.

When the air mattress 10 is not connected to a pump, the output valve 36 releases air when a pre-determined pressure level is exceeded, allowing a patient to slowly settle into the mattress 10. When the air mattress 10 is connected to a pump and pressure to the flexible air cylinders 18a is increased, the area above the foam member 19 enclosed by the arched top inflates with air. The arched top of each flexible air cylinder 18a can retain a volume of air with enough pressure to lift the portion of the patient's body above that flexible air cylinder away from the resilient foam member 19. The mattress 10 is capable of being operated in an alternating pressure cycle with the present invention. With an alternating pressure cycle, one set of flexible air cylinders 18a may be pressurized while other flexible air cylinders 18a are allowed to evacuate air and become depressurized.

FIG. 5 illustrates an alternate embodiment of the flexible air cylinder 18a of the present invention incorporating an arched cavity that is above but independent of the foam member 19. This embodiment encompasses a cavity enclosing the foam member 19 and an arched cavity above the foam filled cavity. Both cavities would include air inlets 34 and air outlets 36 as previously explained (not shown here). This embodiment would allow the foam filled flexible air cylinders 18a to operate in the powered and non-powered format as previously explained, while the arched cavity would have the ability to inflate and deflate when pump is connected.

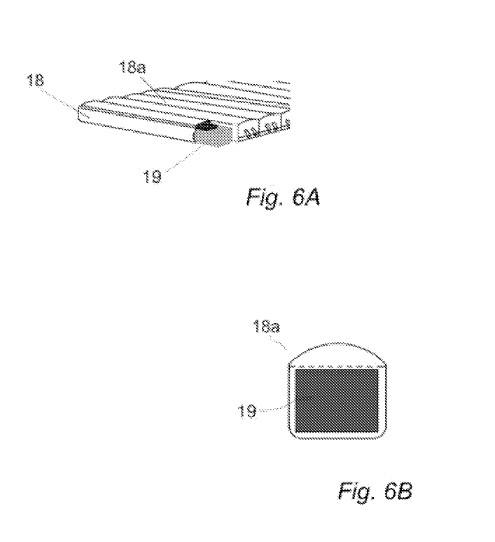

FIGS. 6A-6B illustrate an alternate embodiment of the flexible air cylinder 18a of the present invention incorporating separate but interconnected cavities. The flexible air cylinder 18a comprises a cavity enclosing the foam member 19 and an arched cavity above the foam filled cavity like that shown in FIG. 5, but with the ability for air to pass between the two cavities. Air may be allowed to pass between the two cavities by incorporating breathable material or holes in the area of the flexible air cylinder 18a between the cavities. An air inlet 34 and air outlet 36 (not shown here) would allow the flexible air cylinder 18a to operate in the powered and non-powered format as previously explained.

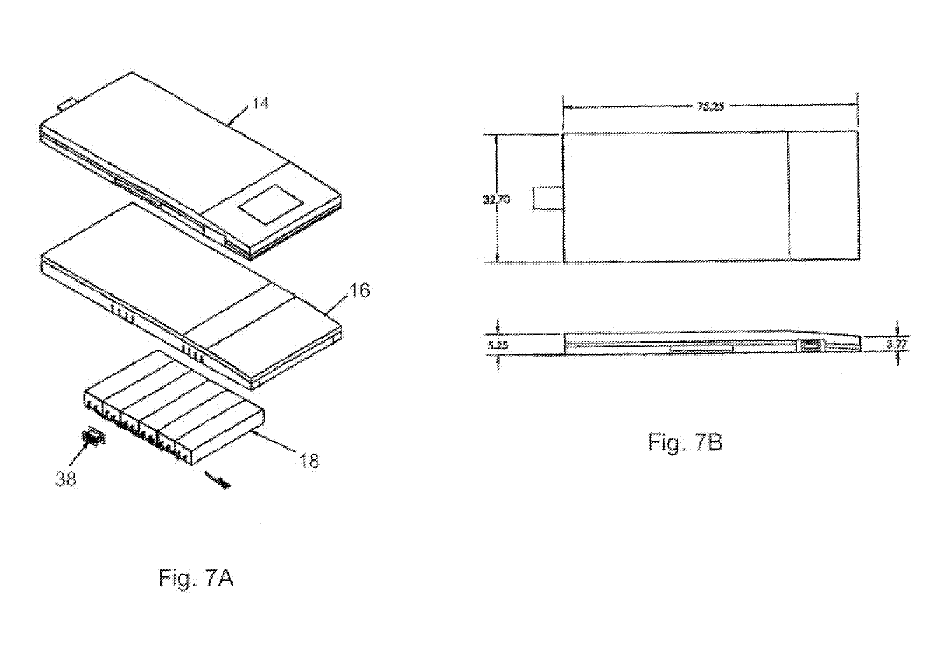

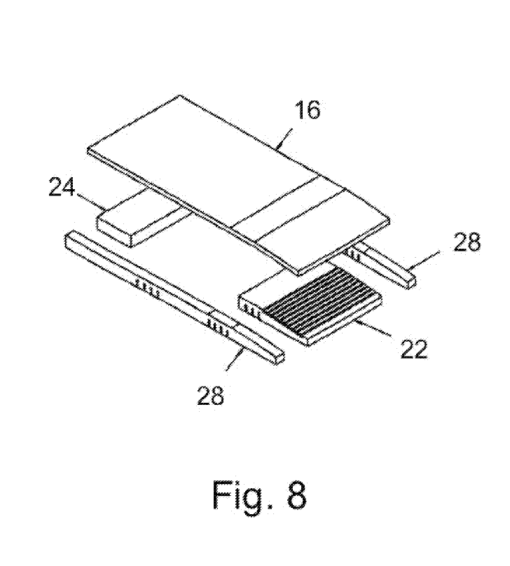

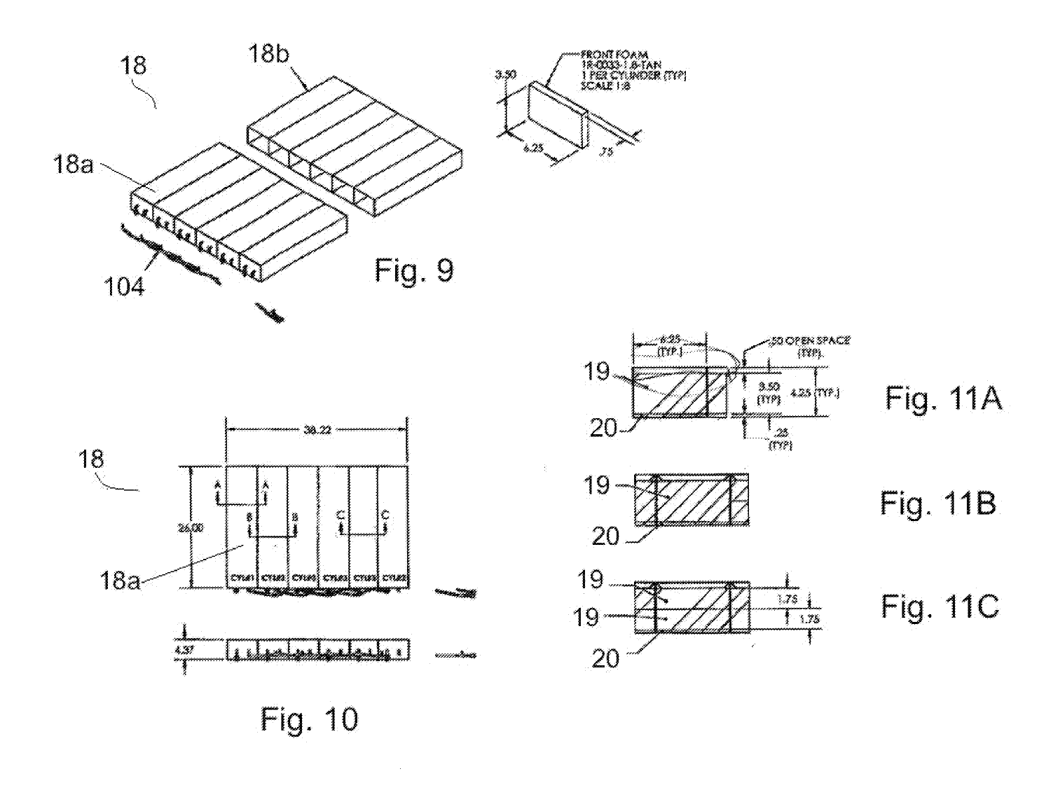

FIGS. 7-11 illustrate alternative embodiments of the present invention. In FIGS. 11A-C, several foam member layers are used in the air cylinder. FIG. 11A illustrates a preferred embodiment comprising a harder foam base layer 20 of preferably 0.25″. The harder foam base layer 20 is affixed to the preferably 3.50″ foam member 19 using adhesive glue. Above the foam member 19 is an air space of preferably 0.5″. FIGS. 11B-C illustrated alternative embodiments of foam base layer 20, foam member 19 and air space.

All features disclosed in this specification, including any accompanying claim, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed:

1. A flexible air cylinder for air mattresses, each air cylinder enclosing a resilient foam member and an air inlet and an air outlet, wherein each flexible air cylinder comprises:
a. a volume above the foam member enclosed by the flexible air cylinder that may be expanded and contracted.

2. The air cylinders of claim 1, wherein the volume above the foam member enclosed by the flexible air cylinder is an arched shape.

3. The air cylinders of claim 1, wherein several flexible air cylinders are connected to each other to form a mattress.

4. The air cylinders of claim 1, wherein the flexible air cylinders are connected to a pump.

5. The air cylinders of claim 1, wherein the flexible air cylinders are connected to a pump which can alternate pressure between sets of air cylinders.

6. The air cylinders of claim 1, wherein the volume of air is enclosed by a second independent flexible air cylinder above the flexible air cylinder with the resilient foam member.

7. The air cylinders of claim 2, wherein a second set of air inlets and an air outlets is affixed to second independent flexible air cylinder.
